(19) United States
(12) Patent Application Publication
(10) Pub. No.: US 2005/0049965 A1
(43) Pub. Date: Mar. 3, 2005

(54) Method and system for calculating reward earned from transactions for voucher or stored value for transactions and method of redeeming the voucher or stored value

(76) Inventor: I-Cheng Jen, Taipei (TW)

Correspondence Address: Harold V. Stotland;42nd Floor, 55 East Monroe Street, Chicago, IL, 60603-5803, US

(21) Appl. No.: 10/916,149

(22) Filed: Aug. 11, 2004

(30) Foreign Application Priority Data
Sep. 3, 2003 (TW) 092124354
Apr. 6, 2004 (TW) 093109512

(51) Int. Cl. G06F 17/00

(52) U.S. Cl. 705/39

(57) ABSTRACT

This invention relates to a method and system for exchanging reward earned from transactions for voucher or stored value for transactions and method of redeeming the voucher or stored value, the system including a primary unit provided at a place where a service provider is located, and a secondary unit provided at where a franchisee is located. When a purchase is made by the consumer at a franchisee designated by the service provider, reward will accumulate and the reward may be exchanged for voucher or stored value when the reward is accumulated to a predetermined amount. In exchanging for the voucher or stored value, the voucher or stored value must be registered at the primary unit of the service provider or deposited in a stored value account. During redemption of the voucher or stored value, the validity of the voucher or balance of the stored value is first automatically affirmed to deter counterfeiting activities.

### FIELD OF INVENTION

This invention relates to a method and system for calculating reward earned from transactions for voucher or stored value for transactions, and a method of redeeming the voucher or stored value, particularly those for registering identification code of the voucher or depositing the stored value in a stored value account in the process of calculating the reward accumulated from expenditure for voucher or stored value, and those capable of performing verification in the process of redeeming the voucher or stored value.

### BACKGROUND

In an era of E-commerce, everyone's wallet is packed with credit cards or affinity cards issued by various banks, department stores, chain stores or franchises.

One transaction mode that is favored among all transaction modes by consumers is the reward program where reward accumulates upon effecting disbursement by credit cards or presenting affinity cards. Many of the credit card issuing banks and affinity card issuing enterprises adopt such a program to encourage consumers to use their cards or to visit their stores.

The reward programs where reward accumulates upon effecting disbursement by credit cards or presenting affinity/corporate cards may vary from bank to bank and store to store. Taking banks or department stores as an example, reward points are earned based on the total amount that a cardholder spends within a month upon effecting disbursement by their credit cards or presenting their affinity/corporate cards, where the points are deposited in the cardholder's account. The cardholder will be able to exchange the accumulated points for the merchandise offered by the banks or department stores. Since most of the expensive merchandise is targeted to be exchanged with a large amount of reward points, the merchandise to be exchanged is not preferred by the consumers such that the consumers may exchange some undesired merchandise, the reward points will be deducted if they are not used within a time limit, the accumulating way for reward points varies from bank to bank and store to store and the reward points of one bank or store cannot be used in another bank or store, such an accumulating way for reward points is very inconvenient for consumers and does not meet the consumers' requirements.

Other enterprises or banks may also adopt a cash reward program that would reward the cardholder with voucher based on a proportion of the total amount that a cardholder spends upon effecting disbursement by his/her credit card or presenting his/her affinity/corporate card, where the voucher may be redeemed as credit in future transaction. The actual forms of the voucher may differ. Most of the vouchers are in the form of gift coupons issued by banks or stores. Since the voucher can be used as cash, most consumers prefer to receive a voucher.

Though vouchers are favored by consumers, they also cause problems as banks and stores will have to train tellers and cashiers as to how to identify counterfeit vouchers, or implement measures that would prevent unauthorized personnel from misappropriating the vouchers entrusted to them. Such problems are particularly critical for enterprises consisting of chain stores or franchise stores because the great number of stores that are dispersedly located with cashiers working on shifts has become one major challenge in the management and identification of vouchers. In addition, the voucher for transactions can only be used in specific chain stores or franchise stores, but not all trades and professions. Therefore, it is inconvenient to consumers, too.

### SUMMARY OF INVENTION

This invention relates to a method and system for calculating reward earned from transactions for voucher or stored value for transactions, and a method of redeeming the voucher or stored value, wherein the method and system can be applied to all franchise stores including not only general enterprises but also all trades and professions. Therefore, the ID card issued by a service provider is a universal ID card which can be used in all the franchise stores. No matter what kind of card (including credit card, affinity card, corporate card, member privilege card, and VIP card etc.) is used, the consumers can receive the reward benefit provided by the service provider, thereby achieving the convenience and wide circulation.

This invention relates to a method and system for calculating reward earned from transactions for voucher or stored value for transactions, and a method of redeeming the voucher or stored value, with the system including a primary unit provided at the place where a service provider is located, and a secondary unit provided at the place where a franchisee is located. The procedures of registering the exchanged voucher or the procedures of depositing and affirming the exchanged stored value must be executed prior to redeeming the voucher or stored value at the franchise stores designated by the service provider.

This invention provides a method and system for calculating reward earned from transactions for voucher or stored value for transactions, where the primary unit will deduct the reward earned by consumers and equivalent to the exchanged amount from the reward account at the time of registering the voucher or depositing the stored value in a stored value account.

This invention also provides a method and system for calculating reward earned from transactions for voucher or stored value for transactions, where the primary unit will first affirm the validity of the voucher or the balance of the stored value is first affirmed prior to redeeming the voucher or stored value, and then void the voucher or deduct the stored value after redeeming the voucher or stored value.

This invention further provides a method and system for calculating reward earned from transactions for voucher or stored value for transactions, where the system will offer consumers additional reward or the franchise stores will offer consumers gifts when purchases are made within a designated period of time.

This invention provides a method and system for calculating reward earned from transactions for voucher or stored value for transactions, where the primary unit will provide information, relevant to the processed reward, voucher or stored value, to the franchise stores in response to consumers' inquiries.

The primary unit and the secondary unit of this invention may operate through a virtual private network (VPN), a communication network or the Internet.

One of the objectives of this invention is to prevent counterfeits or misappropriation as the voucher needs to be registered and the stored value needs to be deposited and affirmed prior to being redeemed in any franchise store. In addition, the reward that is equivalent to the exchanged amount of voucher or stored value will also be deducted from the reward account at the same time to prevent inappropriate registration of the voucher or addition of the stored value, and the validity of the voucher or stored value is further verified while redeeming the voucher or stored value and is voided or deducted after redeeming the voucher or the stored value to deter counterfeiting activities. Furthermore, because the ID card issued by the service provider is a universal ID card which can be used in all the franchise stores including not only general enterprises but also all trades and professions, the ID card can achieve the convenience and wide circulation.

### BRIEF DESCRIPTION OF THE DRAWINGS

These and other modifications and advantages will become even more apparent from the following detailed descriptions of a preferred embodiment of the invention and from the drawings in which:

FIG. 1 is a schematic drawing illustrating the system of this invention;

FIG. 2 is a flowchart illustrating accumulation of the reward when a consumer effects disbursement;

FIG. 3 is a flowchart illustrating the registration of a voucher or depositing of the stored value;

FIG. 4 is a flowchart illustrating the redemption of a voucher or stored value by a cardholder; and

FIG. 5 is a flowchart illustrating the redemption of a voucher or stored value by a non-cardholder.

### DETAILED DESCRIPTION OF THE INVENTION (PREFERRED EMBODIMENTS)

A summary description is first provided based on a preferred embodiment of a system for calculating reward earned from transactions for voucher or stored value for transactions according to this invention. The system includes a service provider and a franchisee, which are a general franchiser and a store owner, respectively, in this embodiment. The franchisees may be of any trade or profession without being limited to retail stores but may also be of any service-providing professions, such as barber shops, restaurants, movie theaters, and car repair shops.

To process information generated in a transaction, the franchiser is equipped with a main computer system (primary unit) while the franchisee is equipped with a sub-computer system (secondary unit). The primary unit and the secondary unit are connected to a network for transmitting information. To ensure safety in transmitting information, techniques relevant to virtual private networks (VPN) may be adopted. The detailed arrangements of the primary unit and secondary unit are described as follows:

The franchise enterprise may issue an ID card, which may be a VIP card, a credit card, an affinity card, a corporate card, a member privilege card, a chip card or a magnetic stripe card to a consumer, turning the consumer into a cardholder. The card may be issued upon adopting the conventional measures, such as requesting the consumer to fill out basic information and entering such information into the system. As discussed previously, the ID card may be a chip card equipped with a read/writable memory chip or a conventional magnetic card equipped with a magnetic region or applied with a magnetic stripe to provide the ID card with readable or read/writable memory features. The ID card may also be a plain card without any memory feature but contains an identification number, a one-dimensional barcode or a two-dimensional barcode. When collaboration is established between the franchiser and a financial institution, the ID card may be equipped with the functions of a bank card, such as a credit card. Whether being equipped with a magnetic stripe, a barcode or a chip, the card includes a code representing the identification of the cardholder, or the so-called card number that may comprise figures only or a combination of texts and figures. When the system described as follows is presented with an ID card, the system will search the number and access information corresponding to the number.

For persons having ordinary skill in relevant art, the card number may be identical to an ID number (such as the social security number) or any random number.

When the cardholder effects disbursement at any franchisee and presents the ID card while effecting the disbursement, the service attendant at the store would enter the number indicated on the card into the secondary unit or load the number stored in the card by a magnetic stripe reader, chip card reader or barcode scanner equipped into the secondary unit. The secondary unit will then transmit such information to the primary unit and request the primary unit to affirm such information, and/or to return information corresponding to the same number to the secondary unit.

The system of this invention may be designed in such a manner that, even when the cardholder did not carry the ID card, the name or ID number of the cardholder may be used as an index by the system so that the primary unit may still return information corresponding to the same index to the secondary unit.

One approach for the franchiser to encourage the cardholder to visit its stores is the accumulation of reward for bringing in more business opportunities. The franchiser may thus formulate different exchange standards for the reward that the cardholder may earn while effecting disbursement at franchisee of different natures, upon considering the spending habits of the cardholder. For example, the reward earned by the cardholder by spending five hundred dollars in a barber shop may differ from that in a restaurant.

The accumulation of the reward may be in the form of points, such as 1,000 points and 1,250 points, or in the form of dollars, such as $1,000 or $1,250.

Another approach for the franchiser is to allow the cardholder to exchange the reward accumulated for voucher or stored value for transaction. The cardholder may choose to exchange the amount of the reward that he/she wishes to exchange for voucher or stored value to be redeemed in a franchisee while keeping the balance of the reward for further accumulation.

The voucher may be in the form of paper, such as gift coupons, rebate coupons or credit notes, or in the form of an electronic file. The stored value may be in the form of E-wallet.

When the cardholder effects disbursement at a franchisee, the system will store the reward that is equivalent to the amount of transaction in the databank of the primary unit. If the card is equipped with a read/writable memory chip, the information relevant to the reward may also be stored in the chip of the card. When the cardholder intends to exchange for voucher or stored value, he/she may choose to do so at any franchisee. By entering the card number of the cardholder into the secondary unit, the system is able to instantaneously display the cardholder's information relevant to the reward. After the cardholder has decided the amount of voucher or stored value to be exchanged for, the system will record the balance of the reward. If the card is equipped with a read/writable memory chip, such information may also be stored in the chip of the card.

According to this invention, registration of the voucher prior to redemption in any franchisee is adopted as a preemptive measure. Each voucher consists of an identification code that may comprise of figures only or a combination of texts and figures, and printed on the voucher in the form of a barcode. To validate the voucher to be redeemed in future transaction, the identification code of the voucher needs to be entered at the time of exchange and stored in the primary unit. Similarly, the stored value needs to be deposited in and affirmed by the system prior to redemption in any franchisee. Accordingly, redemption the voucher and stored value is not limited to cardholders.

According to this invention, another preemptive measure, i.e. deducting the reward that is equivalent to the exchanged amount from the reward account at the time of exchanging for voucher or stored value is adopted.

While effecting disbursement by the exchanged voucher or stored value, this invention allows computation and accumulation of the reward.

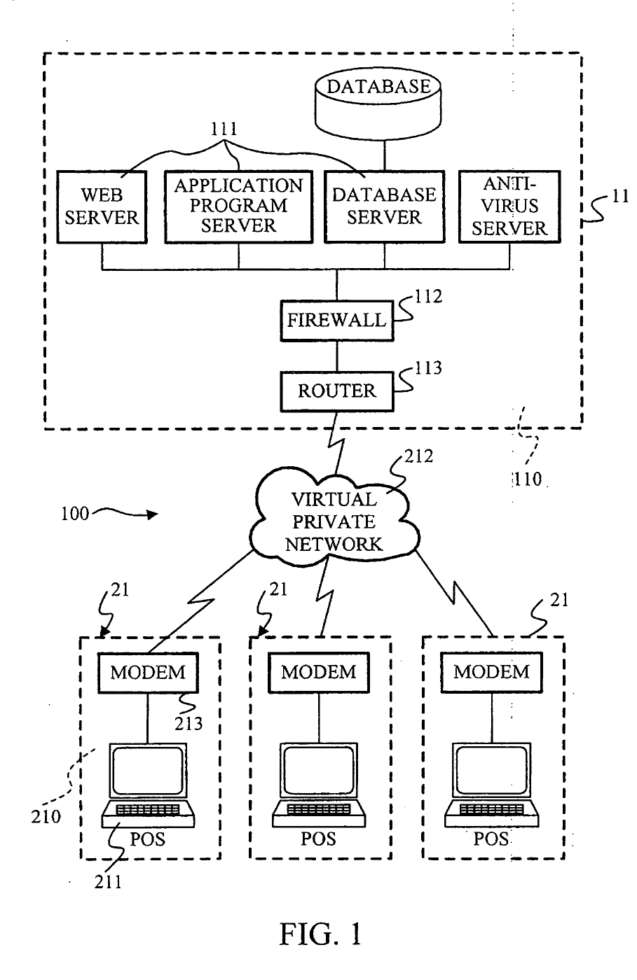

These and other modifications and advantages will become even more apparent from the following description of a preferred embodiment of the invention with reference to FIG. 1.

FIG. 1 is a schematic drawing illustrating the system 100 of this invention, the system 100 including a franchiser 111 (service provider) and various franchisee's stores (store owners) 21. This invention employs a computer system 10, including a primary unit 110 provided at the place where the franchiser is located and secondary unit 210 provided at the place where each of the franchisees is located. The primary unit 110 includes a primary processing unit that may include plural servers 111 (such as a web server, an anti-virus sever, a terminal server and an application program server) each bearing specific duties for processing consumers' information relevant to the transaction, reward, and voucher/stored value, including registering, adding, balancing, exchanging, redeeming and voiding the consumer's information relevant to the transaction, reward, and voucher/stored value, and a databank server managing at least one databank that is electrically connected to the primary processing unit and serving to store numerous consumer information relevant to the transaction, reward, and voucher/stored value, wherein the establishment of the databank is generally achieved by RAID, such as RAID 0 or RAID 3, to meet the high information reading/writing efficacy and the need of failure backup; and a primary communication device electrically connected to the primary processing unit, for receiving information from and transmitting information to a secondary unit via a communication network.

The secondary unit 210 of each of the franchisee, in practice, includes a point-of-sale device (POS) 211 that is at least integrated and on-line with secondary information input device (such as a barcode scanner or a card reader) for entering consumer's information relevant to the transaction, reward and voucher/stored value; a secondary processing unit (such as a computer), electrically connected to the secondary information input device, for processing information relevant to the transaction, reward and voucher/stored value as entered; a secondary communication device electrically connected to the secondary processing unit, for transmitting information to and receiving information from the primary unit via a communication network; a cashing machine; and/or a terminal. Since this invention involves financial transaction mechanisms, for security reasons, the secondary unit 210 at each of the franchisees may be connected to the primary unit 110 via a virtual private network (VPN) 212 or other secure networks. The information transmitted between the primary unit 110 and secondary unit 210 under such a framework is encrypted and authenticated to prevent unauthorized invasion. For persons having ordinary skill in the art, the virtual private network 212 is directed to conventional technology that is constructed based on IPsec communication protocols, and may be realized by software or hardware.

The POS 211 of the secondary unit 210 is on-line with the virtual private network 212 via a communication device (such as a modem 213), but not limited to the communication device. For example, the secondary unit 210 may be on-line with the virtual private network 212 via a local area network (LAN), a router, or a dedicated line. The primary unit 110 is equipped with a fire wall 112 and a router 113. Since the arrangements of and software required for operating these equipments are conventional, their details are not described herein.

When a store participates in the franchise, the franchiser 11 will assign a number to the store and register the same in the primary unit 110.

In this embodiment, the franchiser 11 does not impose limitations on the nature of the business of the store that the franchisee intends to deals in. Thus, the trades and professions in which the franchisee's stores 21 deal within the franchise enterprise may vary. The franchiser 11 may issue applicants with ID cards equipped with or without read/writable memory features. The cards may be issued to the general consumers upon adopting conventional measures, such as requesting the consumers to fill out personal information (including name, social security number and birth date) on an application form, and entering such information into the system of this invention via the secondary unit 210 at the franchisee's store or the primary unit 110 at the franchisee's enterprise and storing such information in the databank of the primary unit. If the card is equipped with memory features, selective information, such as the card number and accumulated reward points, may be stored in the card. The card number may comprise figures only or a combination of texts and figures. In this invention, the card number is an identification code comprising texts and figures. Additional information may be stored in the ID card, such as the date of the previous transaction by the cardholder, if the franchiser 11 desires.

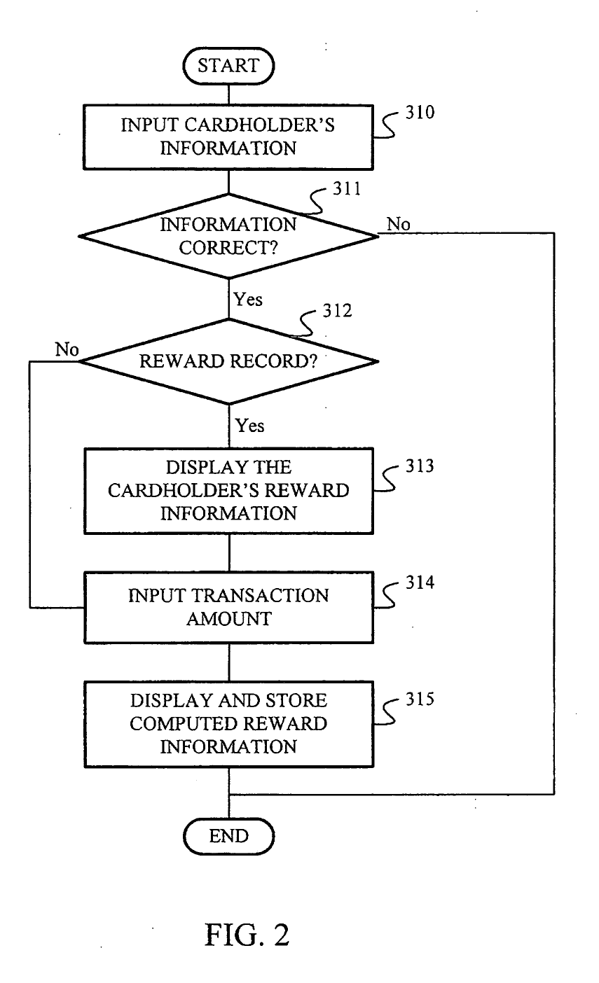

FIG. 2 is a flowchart illustrating accumulation of the reward when a cardholder (consumer) effects disbursement. When the cardholder visits any franchisee for purchase, Step 310, the service attendant will enter the card number after the cardholder presents his/her ID card. The service attendant may load the information stored in the ID card (such as the card number and total reward points) onto the secondary unit by means of a card reader provided on the POS, which information is then displayed on a monitor. The secondary unit would then transmit the card number of the cardholder to the primary unit via a communication device and request the primary unit to affirm and download the information stored to the databank of the primary unit.

If the ID card is not equipped with memory features, the service attendant may enter the card number of the cardholder by means of an input device, which information is then transmitted to a primary unit via a communication device and request the primary unit to affirm and download the information stored to the databank of the primary unit.

The system of this invention may be designed in the way that, even when the cardholder did not carry his/her ID card, the name or ID number of the cardholder may be transmitted to the primary unit from the secondary unit, while the primary unit will download the information corresponding to the cardholder and stored in the databank to the secondary unit. In addition, the system may be designed in a way that the primary unit will provide information relevant to the reward, voucher or stored value in response to the cardholder's inquiry.

Then, in Step 311, after the primary unit receives the card number uploaded by the secondary unit, a complying or non-complying message will be downloaded to the secondary unit, which message may be displayed as “AFFIRMED” or “ERROR.”

In Step 312, reward is automatically accumulated upon expenditure by the cardholder. The primary unit will verify the cardholder's information relevant to the reward, which information is then displayed on the monitor (Step 313). In Step 314, the franchisee will enter the amount of the cardholder's current transaction and way of payment and upload such information to the primary unit. In Step 315, the primary unit will download information relevant to the reward points earned from the current transaction, total reward points and date of transaction to the secondary unit that are computed by the primary unit and stored in the databank, which information is then displayed on the monitor. The secondary unit may store all or part of such information into the ID card and print out the necessary receipt or invoice. However, such information cannot be stored in the ID card if the cardholder did not carry the ID card or if the ID card is not equipped with memory features.

In addition, the primary unit may offer consumers additional reward or the franchisee's stores may offer consumers gifts when the purchases are made within a designated period of time. The system may also be designed in such a way that it will allow the cardholder to update the information stored in the ID card within a designated period of time if the cardholder did not carry the card at the time of transaction to allow accumulation of reward points, or to allow the primary unit to provide information relevant to the processed reward, voucher or stored value to the franchisee's stores in response to the consumers' inquiries.

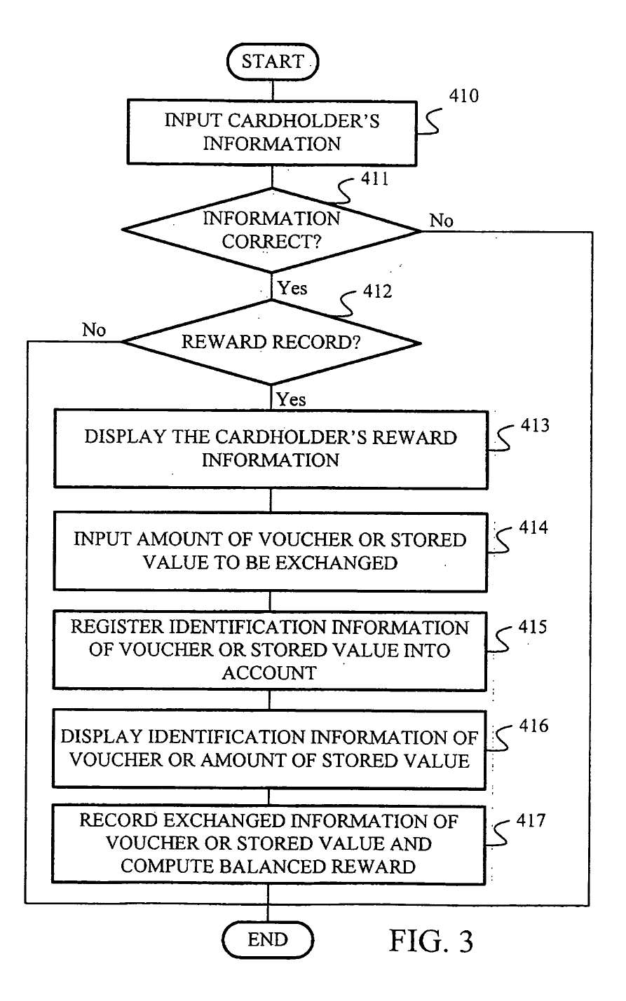

FIG. 3 is a flowchart illustrating the process of exchanging for voucher or the stored value. The cardholder may exchange for voucher or deposit the stored value at any of the franchisees. First, in Step 410, the service attendant will enter the card number after the cardholder presents the ID card. The service attendant may upload the information stored in the ID card (such as the card number and total reward points) into the secondary unit by means of an input device (such as a card reader, a scanner or a keyboard) provided at the POS, which information is then displayed on the monitor. The secondary unit will then transmit the card number of the cardholder to the primary unit via a communication device and request the primary unit to affirm and download information stored to the databank of the primary unit.

Then, in Step 411, after the primary unit receives the card number uploaded by the secondary unit, a complying or non-complying message will be downloaded to the secondary unit, which message may be displayed as “AFFIRMED” or “ERROR.” To ensure accurate information has been retrieved, the primary unit of the system may further perform verification of a password and affirmation of the ID information of the holder.

In Step 412, the system will verify the cardholder's information relevant to the reward, which information is then displayed on the monitor of the secondary unit (Step 413). The cardholder may decide the total number of reward points that he/she intends to exchange for the equivalent voucher or stored value (Step 414). In this embodiment, the voucher may be in the form of paper, such as gift coupons of different denominations, while the stored value may be in the form of a personal account, such as an E-wallet. In addition, each voucher consists of an identification code that may comprise figures only or a combination of texts and figures, and printed on the voucher in the form of a barcode.

After the cardholder has decided the amount of voucher or stored value to be exchanged for, in Step 415, the service attendant will deposit the intended amount for the stored value in the cardholder's stored value account or register the intended amount for the voucher at the system of this invention. An actual embodiment for the registration of the voucher may include entry of the identification code of the voucher (such as by entering the identification code of each voucher by a bar code scanner), whose identification code will then be uploaded to and stored in the databank of the primary unit along with the reward points that have be exchanged for, while displaying the identification code of the voucher entered and the amount of the stored value on the monitor as shown in Step 416. In Step 417, the primary unit will record the reward points that have been exchanged for this time, the balance of the reward and the amount of the voucher or stored value that have been exchanged for this time in the cardholder's log. The primary unit will also download information relevant to the balance of the reward, the amount of the voucher or stored value that have been exchanged for this time, and the date of the exchange to the secondary unit, which information is then displayed on a monitor. If the card is equipped with a read/writable memory chip, the secondary unit may store all or part of such information in the chip of the card and print out the necessary receipt or invoice. Registering the identification code of the voucher at the time of exchanging for the voucher is a preemptive measure adopted by this invention to prevent non-authorized personnel from misappropriating or counterfeiting the voucher.

According to this invention, another preemptive measure, i.e. deducting the reward points that are equivalent to the exchanged amount from the reward account at the time of exchanging for voucher or stored value is adopted to prevent inappropriate registration of the voucher or addition of the stored value.

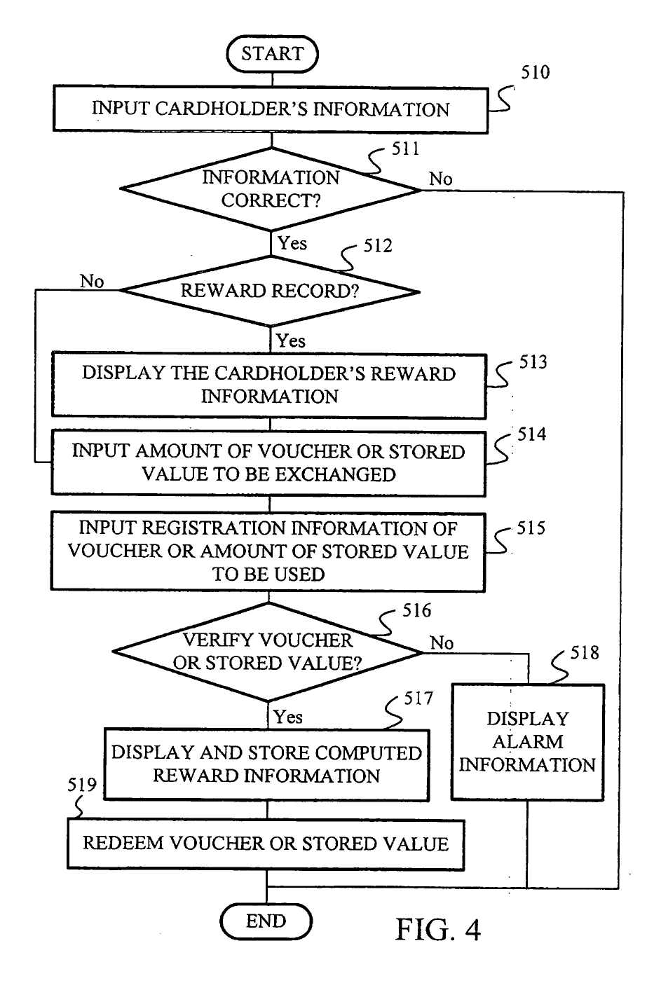

With reference to FIG. 4, when the cardholder requests part of or the entire amount of the purchase to be effected by means of voucher or stored value, in Step 510, the service attendant will enter the card number after the cardholder presents the ID card. The service attendant may upload the information stored in the ID card (such as the card number and total reward points) into the secondary unit by means of a card reader provided at the POS, which information is then displayed on a monitor. The secondary unit will then transmit the card number of the cardholder to the primary unit via a communication device and request the primary unit to affirm and download information stored to the databank of the primary unit.

Then, in Step 511, after the primary unit receives the card number uploaded by the secondary unit, a complying or non-complying message will be downloaded to the secondary unit, which message may be displayed as “AFFIRMED” or “ERROR.” Similarly, to ensure that accurate information has been retrieved, the primary unit of the system may further perform verification of a password and affirmation of the ID information of the holder.

In Step 512, the system will verify the cardholder's information relevant to the reward, which information is then displayed on the monitor of the secondary unit (Step 513).

In Steps 514 and 515, the service attendant will upload the amount of the current transaction, the amount of the voucher or stored value to be redeemed, the respective identification code of the voucher, the balance (when the voucher or stored value is insufficient to balance the entire amount of purchase), and the way of payment to the primary unit. In Step 516, the primary unit will verify whether the identification code of the voucher has been registered or whether the balance of the stored value in the cardholder's stored value account is sufficient. If the identification code of the voucher entered has not been registered or the balance of the stored value in the cardholder's stored value account is insufficient, an alarming signal will be displayed as shown in Step 518 and the system will decline the request for effecting part of or the entire amount of the purchase by means of voucher or stored value. If the identification code of the voucher entered has been registered or the balance of the stored value in the cardholder's stored value account is sufficient, the primary unit will then download information relevant to the reward points earned by the current transaction, total reward points, the amount of voucher or stored value as redeemed, and date of transaction to the secondary unit, which information is then displayed on the monitor, as shown in Step 517. The secondary unit may store all or part of such information in the ID card and print out the necessary receipt or invoice. However, such information cannot be stored in the ID card if the cardholder did not carry the ID card. In step 519, after redemption of the voucher or stored value, the voucher or stored value will be voided by the primary unit to prevent repeated redemption of the same voucher or stored value.

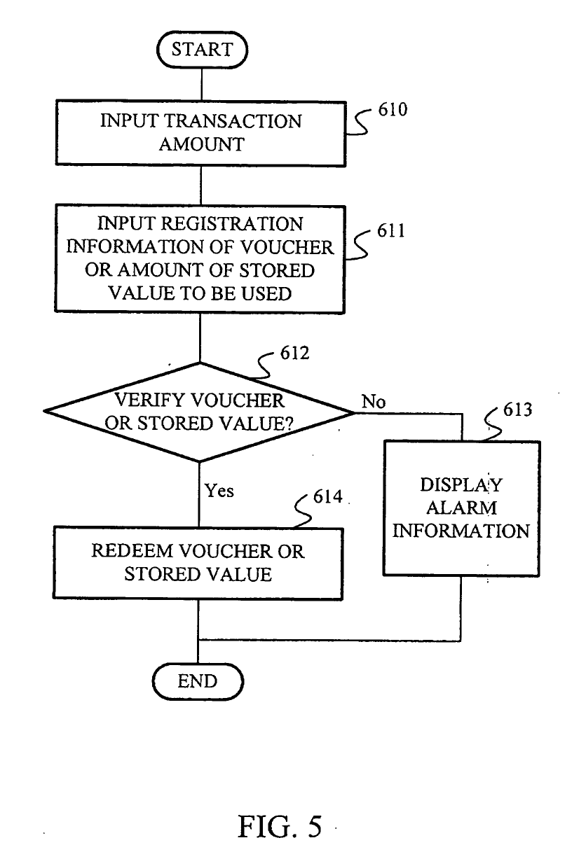

Purchases at the franchisees are not limited to cardholders, but also available to non-cardholders. Thus, redemption of the voucher or stored value is not limited to cardholders only. With reference to FIG. 5, in case a non-cardholder requests part of or the entire amount of the purchase to be effected by means of voucher or stored value at the time of effecting disbursement, in Steps 610 and 611, the franchisee will upload the amount of the current transaction, the amount of the voucher or stored value to be redeemed, the respective identification code of the voucher, the balance (when the voucher or stored value is insufficient to balance the entire amount of purchase), and the way of payment to the primary unit. In Step 612, the primary unit will verify whether the identification code of the voucher has been registered or whether the balance of the stored value in the cardholder's stored value account is sufficient. If the identification code of the voucher entered has not been registered or the balance of the stored value in the cardholder's stored value account is insufficient, an alarming signal will be displayed as shown in Step 613 and the system will decline the request for effecting part of or the entire amount of the purchase by means of voucher or stored value. If the identification code of the voucher entered has been registered or the balance of the stored value in the cardholder's stored value account is sufficient, the primary unit will then be voided by the primary unit to prevent repeated redemption of the same voucher or stored value, as shown in Step 614. The secondary system, of course, will still print out the necessary receipt or invoice.

In the process of exchanging for the voucher by the cardholder, the identification code of the voucher must be registered at and stored in the primary unit. At the time of redeeming the voucher by anyone, verification of the voucher must be executed. The franchisee needs to enter the identification code into the system for verification. The voucher can be redeemed only if the identification code has been registered at the system. Such a process is an additional preemptive measure adopted by this invention.

The effects of this invention can be realized based on the above description. In summary, according to this invention, the voucher or stored value can be redeemed only if it has been registered as verified by the system to prevent misappropriation by unauthorized personnel. The reward that is equivalent to the exchanged amount is also deducted from the reward account at the time of exchanging for the voucher or stored value to prevent inappropriate registration of the voucher or addition of the stored value. The validity of the voucher or stored value is further verified while redeeming the voucher or stored value to deter counterfeiting activities.

Though the franchiser as used in the above embodiment is directed to a general enterprise that is open to franchisees of all trades and professions, this invention, however, is not limited to general franchisees, but available to franchisers of any specific trade and profession too. Furthermore, other than franchisers, this invention may also be employed by department stores, variety stores and grocery stores.

1. A method of exchanging reward earned from transactions for voucher or stored value for transactions, to be implemented in a system having a primary unit provided at the place where a service provider is located, and at least one secondary unit provided at the place where a franchisee's store is located, the method comprising the steps of:
entering ID information of a consumer through the at least one secondary unit;
entering an amount of voucher or stored value that the consumer intends to exchange through the at least one secondary unit;
exchanging the reward contained in the consumer's reward account for the amount of voucher or stored value that the consumer intends to exchange at the primary unit;
registering the exchanged voucher or depositing the exchanged stored value into the consumer's stored value account at the primary unit; and
deducting the reward earned by the consumers that is equivalent to the exchanged amount from the consumer's reward account at the primary unit.

2. The method of claim 1, further comprising the steps of verifying a password and affirming the ID information of the consumer at the primary unit.

3. The method of claim 1, wherein the step of registering the exchanged voucher further includes the steps of entering and storing the ID information of the exchanged voucher.

4. The method of claim 1, wherein the voucher is in the form of paper.

5. The method of claim 1, wherein the stored value is in the form of E-wallet.

6. The method of claim 1, further comprising the step of offering the consumer at the primary unit additional reward or offering the consumer at the franchisee a gift when a purchase is made by the consumer within a designated period of time.

7. The method of claim 1, further comprising the step of providing from the primary unit information relevant to the processed reward, voucher or stored value to the secondary unit.

8. A method of redeeming voucher exchanged with reward earned from transactions, to be implemented in a system having a primary unit provided at the place where a service provider is located, and at least one secondary unit provided at the place where a franchise store is located, the method comprising the steps of:
entering ID information of a consumer through the at least one secondary unit;
entering information of the voucher that the consumer intends to redeem and information relevant to the current transaction through the at least one secondary unit;
affirming whether the voucher that the consumer intends to redeem has been registered at the primary unit;
balancing the current transaction with the voucher that the consumer intends to redeem upon affirming that the voucher has been registered at the primary unit; and
voiding the voucher that the consumer intends to redeem at the primary unit.

9. The method of claim 8, further comprising the steps of verifying a password and affirming the ID information of the consumer at the primary unit.

10. The method of claim 8, further comprising the step of offering the consumer at the primary unit additional reward or offering the consumer at the franchisee a gift when a purchase is made by the consumer within a designated period of time.

11. The method of claim 8, further comprising the step of providing from the primary unit information relevant to the processed reward or voucher to the secondary unit.

12. A method of redeeming stored value exchanged with reward earned from transactions, to be implemented in a system having a primary unit provided at the place where a service provider is located, and at least one secondary unit provided at where a franchisee is located, the method comprising the steps of:
entering ID information of a consumer through the at least one secondary unit;
entering information of the stored value that the consumer intends to redeem and information relevant to the current transaction through the at least one secondary unit;
affirming whether the stored value deposited in the consumer's stored value account is sufficient at the primary unit;
balancing the current transaction with the stored value that consumers intends to redeem upon affirming that the stored value deposited in the consumer's stored value account is sufficient at the primary unit; and
deducting the stored value those consumers intends to redeem with the stored value deposited in the consumer's stored value account at the primary unit.

13. The method of claim 12, further comprising the steps of verifying a password and affirming the ID information of the consumer at the primary unit.

14. The method of claim 12, further comprising the step of offering the consumer at the primary unit additional reward or offering the consumer at the franchise store a gift when a purchase is made by the consumer within a designated period of time.

15. The method of claim 12, further comprising the step of providing from the primary unit information relevant to the processed reward or stored value to the secondary unit.
